(19) United States
(12) Patent Application Publication
(10) Pub. No.: US 2023/0005002 A1
(43) Pub. Date: Jan. 5, 2023

(54) SYSTEM AND METHOD FOR AUTOMATED SELF-ORGANIZING WORKERS IN AN ONLINE PLATFORM AND INCENTIVE DISTRIBUTION

(71) Applicant: Guowang Miao, Conroe, TX (US)

(72) Inventor: Guowang Miao, Conroe, TX (US)

(21) Appl. No.: 17/362,988

(22) Filed: Jun. 30, 2021

(51) Int. Cl. G06Q 30/02; G06Q 40/00; G06Q 50/00; G06Q 10/10; G06Q 10/06

(52) U.S. Cl. CPC G06Q 30/0214; G06Q 40/125; G06Q 30/0215; G06Q 50/01; G06Q 10/1093; G06Q 10/06398; G06Q 2230/00

(57) ABSTRACT

A computer implemented system and method is provided for automated multi-tier self-organizing of freelancers on any platform or marketplace over web to provide freelance services over the platform or marketplace in a group and to share the incentive, commission or bonus from working of other members of group as well as from working of down-line freelance workforce of multi-tier organization to motivate automatic evolution of groups for better freelance services on the platform or marketplace.

### FIELD OF INVENTION

The present invention relates to a computer implemented system and method to self-organize the online workers in an online platform and marketplace for a group freelance service provisioning and multi-tier incentive or bonus distribution.

### BACKGROUND

In current time, the internet has become the venue for displaying or selling each and every product, content, service and even skills which attract tremendous number of online workers, freelancers, independent contractors, content creators and so on to join the internet based freelance platforms and exhibition channels to exhibit their skills or work remotely using the internet. For example, freelance experts are increasingly joining the Internet sales channel and platforms to enhance awareness of their services. Online work marketplaces and platforms help clients and contractors, i.e. freelance experts, across the country, region, or globe, to connect with each other and work for each other.

But, the problem with the present online work marketplaces and platforms is that they use a referral method but with one-time bonus or commission for the freelancers or contractors who promotes the platform and joins other skilled persons with the platform as a service provider which normally fails to motivate the freelancer to bring more skilled freelancer to join with the platform resulting in negative growth rate of the platform.

Even as the online platform grows, a fundamental problem that the platform has to solve is how to organize the online workers so that they can provide the best services to clients or platform visitors. Without such help, the growth of freelance workers on the platform slows down and the quality of services provided by the platform deteriorates. Also, with independent working of every freelancer over the online platform decreases growth rate and competitiveness of freelancer as compared to working of freelancers in a group.

The platform availability fails because of the reason that they don't allow the freelancers to form a group or a team with other freelancers of the platform or refrain one group to connect with other group over the platform to share information with each other resulting in decrease in potential of service provisioning in the online platform.

Moreover, the hiring process of online workers is not only time consuming, but it is also error-prone since it is usually difficult to thoroughly assess the qualifications of each and every online worker (e.g. education and work experience from schools and companies that are unknown), thereby hard to guarantee quality of services provided to clients. Understanding and modelling the hiring of online workers is challenging not only due to the variety of skills and expertise of online workers globally and the diversity of them, but also due to the heterogeneity of work requirements of clients.

Therefore, there exist a need of a computer implemented platform with an incentive module and scheme to provide commissions, incentives and bonus to freelancer for successful working with other members of the group that may encourage the freelancer to further promote the platform. Further, there exist a need of a self-organizing freelance platform that may allow freelancers to form and work in a team to provide better service to clients. Moreover, there exist a need of a self-organizing platform that may allow a freelancer to select the mentor, select the group and/or change the mentor or group to better handle the dynamics of client's demand.

### SUMMARY

Various implementations of methods within the scope of the appended claims each have several aspects, no single one of which is solely responsible for the desirable attributes described herein. Without limiting the scope of the appended claims, some prominent features are described herein. Details of one or more implementations of the subject matter described in this specification are set forth in the accompanying drawings and the description below. Other features, aspects, and advantages will become apparent from the description, the drawings, and the claims.

The present invention provides a computer implemented system and method for automated multi-tier self-organizing of freelancers on any platform or marketplace over web to provide high-quality freelance services over said platform or marketplace in a group and to share the commission or bonus from working of other members of group as well as from working of down-line freelance workforce of multi-tier organization.

According to one embodiment, the system of the present invention is made of a computer implemented web based self-organizing freelance (SOF) system, and hardware components including an input/output user interface, a processor, a memory module and a database all of which are interconnected and communicatively coupled with each other, wherein the user interface allows user to access the system to input data and to receive notifications from the system. The processor is configured within the servers of the system to carry out the instructions stored within the memory of the system over the data of users of the system. Also, it saves the said processed data over databases of the system.

According to one embodiment, the system includes a computer programs instructions stored within the non-transitory computer-readable storage medium (memory) provided to direct a computer or other programmable data processing apparatus to execute said computer program instruction for working of each module of the self-organizing freelance system, wherein the non-transitory computer-readable storage medium is any device used for storing the data including Read Only Memory (ROM), Random Access Memory (RAM), Magnetic Disk Storage Medium, Optical Storage Medium, or Flash Memory Devices etc.

According to one embodiment, the system of automatic self-organizing of freelancers in multiple tiers is provided to encourage any freelancers, content creators or any other contractors to promote the marketplace through their own channels by providing proper incentives for the freelancers for their own work as well as for other members of multi-tier arrangement down to the said freelancers. This incentive scheme of present system motivates the freelancers to attract other people such as their friends, colleagues to join said freelancer and work on a project together as a group. The system allows others to join the hierarchy of a first freelance worker or automatically arranges the workforce in a manner such that the freelancer may also have the commission earning for the work done by other members of the group over the internet.

According to one embodiment, the self-organizing freelance system of present invention includes or is made of a mentorship module or a group formation module, a group evolution module, and a payment calculation module. According to one embodiment of present invention, the group formation module is provided to allow a mentor freelancer, aka group head, to create a group by promoting and sharing referral to potential freelance workers to join the platform and the group of said mentor freelancer over the self-organizing freelance platform of present invention thus allowing the mentor freelancer to earn a reward earning or bonus from the earning of all the freelance members of the group.

According to one embodiment, the system may request the user for the referral of the mentor under which the user desires to join. According to one embodiment, the Group Formation Module of present system allows the mentor to share the referral, which may be in the form of a clickable link or a code, using which the user may join the online marketplace as a downline or as a team member to said mentor freelancer, wherein the mentor freelancer may be a member of another group of the platform.

According to one aspect of present invention, the mentorship module, aka the group formation module, is further provided to allow freelancer to form teams automatically to work on freelance jobs on the freelance platform which in turn may provide better service to client over the platform, as in most cases, services provided by a team is better than an individual freelancer. Further, the group formation module may allow at least one team of the platform to be connected with the at least one other team through group head of one team so that they may share information with each other using a communication tool, thereby forming a complete network working on the online platform.

According to one embodiment, the group evolution module of the multi-tier freelance platform of present invention is configured to allow any user or a group member to change the mentor or a mentor to kick out a member of his group. Further, the group evolution module of present invention is provided to allow the automatic evolution of teams so that they may better handle the dynamics of client demands. According to one embodiment, the group evolution module of present system further facilitates change of group members in the group which includes adding a new group member, removing an existing group member, transferring a group member into another group, and banning a group member from participating group activities for a period of time or permanently.

According to one embodiment, the payment calculation module of present system is made of a freelance earning calculation module and a multi-tier incentive calculation module, wherein the freelance earning calculation module is provided to calculate direct earnings of the freelancer while the incentive calculation module is configured to calculate incentive for freelancers for recruitment of others into the multi-level self-organizing freelance platform as a downline freelancer and forming own working group, thereby becoming the mentor of the recruited freelancers and the group mentor. Also, the incentive calculation module also allows a freelancer to earn compensation on the earnings of other freelancers.

According to one embodiment, this commission and incentive schemes by the incentive calculation module of present system encourages hiring of more skilled team members by the group or joining more skilled teams by the freelancers, which indirectly increases efficiency of the group to successfully complete the tasks and fulfill the requirements of the clients/visitors over the platform thus helping with growth of each freelancers, groups as well as platform itself. Also, hiring of capable team members by the existing freelancers/mentors over the platform eliminates need of exhaustive examination of the freelancer by the administration team of the system of present invention.

The system of present invention allows freelancers in the group to discuss a project or ask for help using chat and/or email and/or any other communication tool provided by the present system. Further, the system and present self-organizing freelance platform allows the freelancer members of a group to form a forum or meeting where they may learn from each other thus creating a micro eco-system in each group which may increase work bonding and understanding between the members. According to one embodiment, each mentor freelancer of the group may also be a group member to other group which enables information sharing between two groups through the mentor and vice versa in exchange of incentive to the mentor freelancer.

### BRIEF DESCRIPTION OF DRAWINGS

FIG. 1 illustrates interface diagram of user with one embodiment of the invented system.

FIG. 2 shows a detailed example diagram of the invented system.

FIG. 3 shows functional components of the invented system

FIG. 4 shows a self-organized multi-tier freelancer tree structure of the multi-level SOF platform of present system

FIG. 5. is an exemplary flow diagram illustrating method of mentorship change in the Group Evolution Module of present system

FIG. 6. illustrates an exemplary flow diagram illustrating a method of Multi-Tier Incentive Calculation Module

### DETAILED DESCRIPTION OF INVENTION

The technology of the present application is described with specificity herein to meet statutory requirements. However, the description itself is not intended to limit the scope of this patent application. Rather, the inventors have contemplated that the claimed subject matter also might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. The specification and drawings are, accordingly, to be regarded in an illustrative rather than a restrictive sense.

For the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Although a flowchart may describe the operations as a sequential process, many of the operations can be performed in parallel or concurrently. In addition, the order of the operations may be re-arranged. Structures and functionality presented as separate components in example configurations may be implemented as a combined structure or component. Similarly, structures and functionality presented as a single component may be implemented as separate components.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented or computer-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (Access Point)).

In some example embodiments, the processors or processor-implemented modules may be located in a single geographic location (e.g., within a home environment, an office environment, or a server farm). In other example embodiments, the processors or processor-implemented modules may be distributed across a number of geographic locations.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

A “storage medium” may represent one or more devices for storing data, including read only memory (ROM), random access memory (RAM), magnetic disk storage mediums, optical storage mediums, flash memory devices and/or other computer-readable mediums for storing information. The term “computer-readable medium” includes, but is not limited to portable or fixed storage devices, optical storage devices, wireless channels and various other mediums capable of storing, containing or carrying instruction(s) and/or data.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

According to one embodiment, the present invention provides a system and method of working for automated multi-tier self-organizing of freelancers over any web based online platform or workplace for providing a high-quality freelance services. The web based online platform or workplace, according to present invention, may be any platform where a freelancer may share his/her creativity or content in exchange of earning from the platform over the internet. According to one embodiment, the platform may be any online freelance platform, any crowdsourcing content platform or any other platform where the user contributes content and make earnings.

According to one embodiment, the system provides a platform for any freelancer, content creator or any other contractor to promote his/her content online to get the rewards for direct work by the user as a freelance earning for own content. Further, the system allows others to join the hierarchy of a first freelance worker and automatically arranges the workforce in a manner that the first freelancer may also have the commission earning from the work done by other members in arranged in hierarchy of the first freelancer.

According to one embodiment, the system of present invention comprises a server and a database, wherein the processor is configured within the server of the platform to carry out the instructions stored within the memory of the system over the data of the freelance user of the platform. Also, the processor saves the said processed data over the server to create a database of the system.

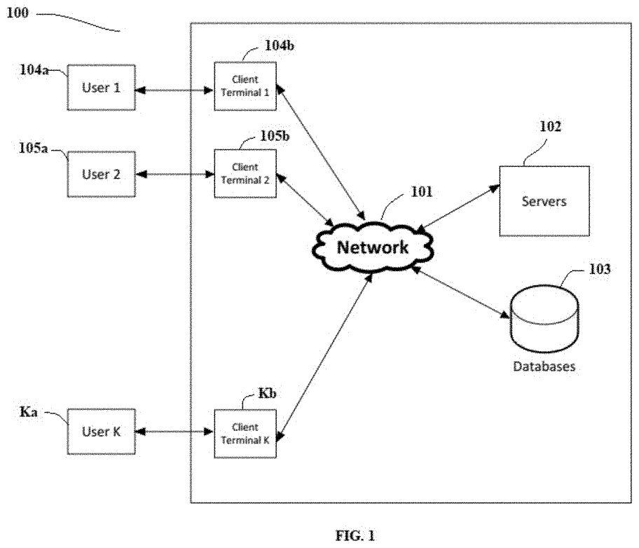

Referring to FIG. 1 which shows an example interface of the user interacting with one embodiment of the self-organizing freelance system, wherein users k (104a, 105a . . . Ka) are accessing an example system, which is a computer implemented freelance platform or marketplace, through client terminals (104b, 105b, . . . , Kb), which is provided by said freelance platform. According to one embodiment, said client terminals are any of a web browser like Microsoft Edge, Google Chrome, Firefox, Android App, iOS app, an executable software program, or alike and wherein the computer implemented platform is a web based freelance platform which is accessible over the network 101 (internet) via any network. The system of present invention may further include one or multiple servers 102 and one or multiple databases 103 communicatively coupled with the web based freelance platform of present system.

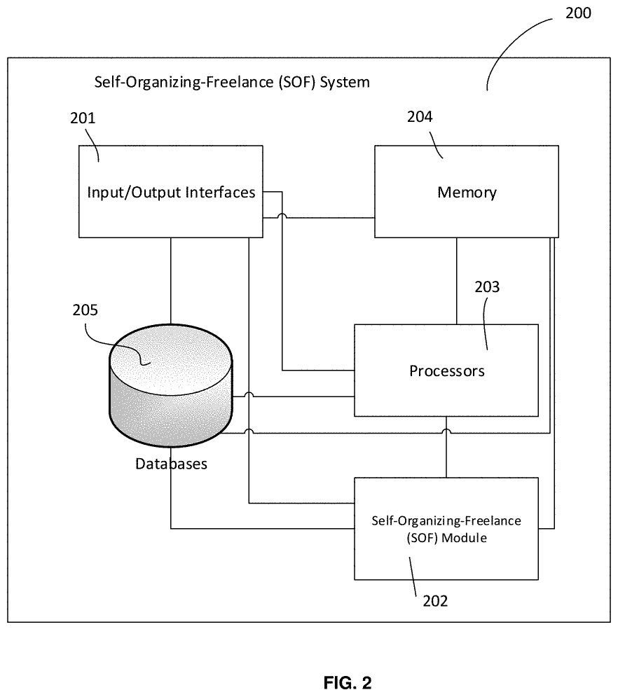

FIG. 2 illustrates a block diagram of hardware configuration of present self-organizing freelance system. According to one embodiment, the system 200 of present invention comprises one or more input/output user interface 201, one or more processors 203, one or more pieces of memory 204 and one or more databases 205. It can be appreciated that any modules, components, functions of the present invention may be distributed, implemented, and executed in different time slots, different locations and different servers. According to present embodiment, the input/output (I/O) interfaces 201 are configured to receive and transmit data. For example, the I/O interface 201 may receive communications from various freelance individuals. The I/O interface 201 may accept input from an input device such as, but not limited to, a keyboard, keypad, touchpad, or mouse. Further, the I/O interface 201 may display output on a display device. According to one embodiment, the I/O interface 201 may be any of the smart user device such as smartphone, laptop, PC or any other specific programmable smart device.

A memory module 204 is provided to store the algorithms, programs, and instructions for working of present self-organizing freelance system. According to one embodiment, memory 204 may be any magnetic, electronic, or optical memory. An example of memory may be dynamic random access memory (DRAM).

According to one embodiment, the processor 203 of present invention is configured and communicatively coupled with the memory 204 to carry out instruction and programs for working of different modules of present self-organizing system stored within the memory 204. The system 200 of present invention further includes one or more database 205 which is configured to store various information related to the freelancers that are providing services on the freelance platform. This information may include but not limited to the actual job information, transactions information, earnings information, contact information, referral information of freelancers.

According to one embodiment, the web based freelance platform of present invention may identify user with a user identifier. A user identifier may be a string of letters, numbers, other characters, or any mix of them. Further, the freelance platform may identify job listing information with a job identifier. Job identifier may be a string of letters, numbers, or other characters.

In one embodiment of the invention, the self-organizing freelance system allows a user or freelancer to promote the platform over his/her personal medium, channel or website to recruit skilled and capable other candidate freelancers such as friends or colleagues of said freelancer as a downline or group member of said freelancer and become mentor, aka mentor freelancer or group head, of the recruited candidate freelancers. The whole group or part of the group of a freelancer may work together as a team over any specific task over the platform and earn direct income for the self-work as well as indirect income such as incentive, commission, or bonus income for the work done by or earnings earned by the other members of the group or downline members.

According to one embodiment, the mentor freelancer, aka group head, evaluates the potential or skill of new freelancer by himself/herself as to recruit best talent in the group which may provide best results to the client's requirement over the freelance platform which in turn results in growth of freelancers, group as well as platform itself. Also, such evaluation of new members by the mentors or promoter freelancer may potentially eliminate need of exhaustive examination of skills of the new users by the administration staff of the freelance platform.

According to one embodiment, the self-organizing freelance system allows a first freelancer to share a referral to a second freelancer via message in form of code or direct link using which the second freelancer may join the platform and become a member freelancer of the group of the first freelancer and a downline to the first freelancer.

According to one embodiment, the self-organizing freelance system allows online work force, aka freelancers, to work as a group or team over a selected project or job. The system allows more than one group members to work on a selected project or job, communicate with each other to share knowledge, teaching, etc. which creates a micro eco-system over the platform that helps in skill growth of freelancers over the platform. Examples of the communication tools within a group includes, but are not limited to chat, online messenger, forum discussion, etc.

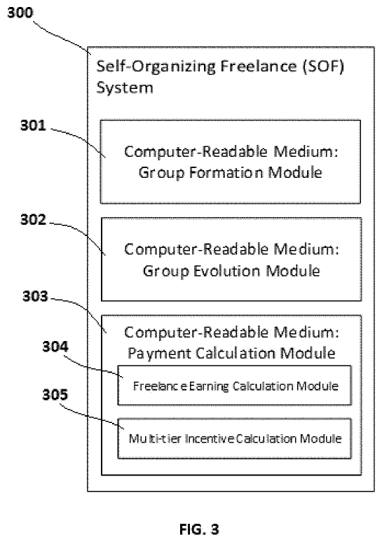

Referring to FIG. 3, which depicts an example of the functional logic components of said self-organizing-freelance (SOF) system 300. According to present embodiment, the system of present invention comprises a Group Formation Module 301, a Group Evolution Module 302, and a Payment Calculation Module 303. The Payment Calculation Module 303 further comprises a Freelance Earning Calculation Module 304 and a Multi-Tier Incentive Calculation Module 305, to calculate and disburse direct earning from work of a freelancer as well as indirect earning from working of the other freelancers, such as downline and/or group members.

According to one embodiment, the multi-tier incentive calculation module 305 of present invention is provided to calculate and provide an incentive and/or commission and/or bonus to the first freelancer over the platform for successful completion of work or task by the group members or downline freelancers of first freelancer. Also, the multi-tier incentive calculation module 305 may further provide earning or bonus from earning of the any downline freelancer in a multi-tier arrangement of present system regardless of their level in the arrangement tree.

According to present embodiment, the incentive scheme implemented in the multi-tier incentive calculation module 305 of present system 300 encourages the freelancers over the platform to promote the platform and system with other skilled and potential freelancers to join the platform and work with first freelancers in a group to successfully complete the tasks over the platform. Joining of skilled freelancers with the system and platform increases success of completion of tasks thus efficiency or efficacy of each individual freelancer of the group resulting in better performance of group and further promotion of the platform.

According to one embodiment, the incentive scheme implemented in the multi-tier incentive calculation module 305 of present system further encourages the first freelancers to recruit the skilled freelancers into the multilevel self-organizing freelance platform and join as downline freelancer to the first freelancer in automated multi-tier arrangement by the system of present invention. According to one embodiment, the system of present invention further allows the first freelancer to create a group with one or more downline members of first freelancer in a multi-tier arrangement, thereby becoming mentor of the group and the recruited freelancers, wherein the platform provides incentive to the first freelancer based on the direct earnings of the first freelancer as well as from the earning of the other members of the group of the first freelancer thus encouraging the first freelancer to promote the platform over his/her personal channels to bring as many potential and capable freelancers as possible over the platform as group members of the first freelancer.

### Group Formation Module

According to present embodiment, in the self-organizing freelance system 300, the Group Formation Module 301 may be configured to interact with various APIs of third-party systems to enable interoperability with the self-organized freelance system 300. For example, the Group Formation Module 301 is configured to interface with a social network API of a social network, which is hosted by the freelance system or a separate third-party system, to facilitate referral sharing, user invitations, registrations, products/services sharing, completing purchases, etc. via the Social network (e.g., messages, newsfeed items, etc.).

According to one embodiment, the Group Formation Module 301 allows a first freelancer of the platform to promote the freelance platform with friends, colleagues, family members or any other person, who may join the freelance platform as a second freelancer and become a group member of the first freelancer and may work on projects, jobs, and tasks together. According to one embodiment, the first freelancer may evaluate the skills of the second freelancer and choose to accept or reject the second freelancer as a team member to make his/her team more skilled and better prepared for meeting client requirements. This automatically eliminates need of exhaustive examination of skills and potential of new freelancers by the administration staff of the freelance platform.

In one embodiment of the invention, the Group Formation Module 301 allows a first freelancer to share the referral code in forms including but not limited to a message or a link. A second freelancer may use the referral code to join the group of the first freelancer. According to one embodiment, once the second freelancer enters the referral code of the first freelancer or clicks on the referral link, the Group Formation Module 301 of present invention automatically organizes the second freelancer as a downline to the first freelancer in a multi-tier arrangement of present system. According to one embodiment, the system further allows the first freelancer to accept the second freelancer as a member of the first freelancer's group to work together on a project or job. According to one embodiment, the system further allows the second freelancer to form a team with some other group members of the first freelancer's group to work together on a project or job.

In one embodiment of the invention, the Group Formation Module 301 may further provide communication tools that allow members of one group or one team to communicate with each other. Such communication tools include but not limited to chat, online messenger, email group, forum, video conference, calendar sharing, and so on. For example, in a selected project, three freelancers in a group may form a team to work on the project together and use one of the tools to share questions and answers, progresses, reports, and so on. A group head may use the communication tools to organize weekly seminars within the group so that his group members may communicate with each other to share knowledge, teaching, etc. which creates a micro eco-system over the platform that helps in skill growth of each freelancer over the platform.

In one embodiment of the invention, the group association between a first freelancer and a second freelancer is performed by an exchange of information between the freelancer and the Group Formation Module 301 of the self-organizing freelance system, and such information need to include unique identification information of the first freelancer, wherein the identification information is used to uniquely identify the first freelancer on the freelancer platform. For example, said identification information is any of a referral code, a driver's license number, a URL that contains a referral code, a QR code that contains a referral code, and so on. After receiving said information, the Group Formation Module 301 records the first freelancer as the mentor, aka group head of the second freelancer. The Group Formation Module 301 may also record the second freelancer as the downline freelancer, or group member, of the first freelancer. According to present embodiment, each freelancer may have an association with one or more downline freelancers, each of which may have their own one or more downline freelancers, thereby forming various logical multi-tier tree arrangement.

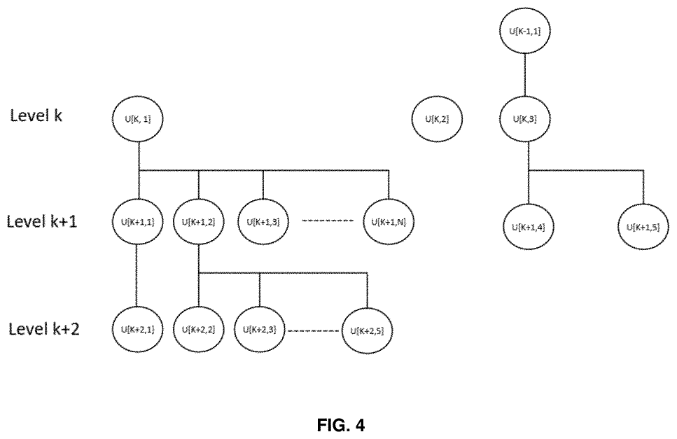

FIG. 4 shows one such multi-tier tree arrangement with each circle representing a freelancer. U[A,B] indicates that the freelancer is the B_th user on level A in the multi-tier self-organizing freelance platform. In an exemplary embodiment, a freelancer U[K,1] is a registered user on an online freelance platform and may provide freelance services to clients. To motivate freelancer U[K,1] to provide better freelance services and promote the freelance platform, freelancer U[K,1] is allowed to recruit group members, such as, U[K+1,1], U[K+1,2], . . . , U[K+1,N], which may further recruit their own group members such as U[K+2,1], U[K+2,1], . . . , U[K+2,5]. Freelancer U[K,1] is allowed to earn from the earning of the downline freelancers, U[K+1,1], U[K+1,2], . . . , U[K+1,N], and U[K+2,1], U[K+2,1], . . . , U[K+2,5].

Each freelancer, e.g. U[k,1], may be at the top of his own tree arrangement. Each freelancer, e.g. U[k+1,1], . . . , U[k+1,N], below the freelancer, U[k,1], of the multi-tier tree arrangement may be said to be in direct downline with the freelancer U[k,1]. According to this configuration, the Group Formation Module automatically self-arranges all of the freelancers, U[k+1,1], U[k+1,2], . . . , U[k+1,N], that the freelancer U[k, 1] personally recruits into the multi-tier self-organizing freelance system. If these freelancers also recruit other freelancers, e.g. U[k+2,1] and U[k+2,2], these other freelancers, e.g. U[k+2,1] and U[k+2,2] are arranged on the second level of this freelancer, e.g. U[k,1], and so on automatically by the Group Formation Module. These recruiting trees are extended to include additional freelancers personally recruited by any of the freelancers shown in FIG. 4.

By way of example, FIG. 4 illustrates three freelancers at an arbitrary level K, U[K,1], U[K,2], and U[K,3]. U[K,3] has an upline freelancer, also called mentor freelancer, U[K−1,1], while U[K,1] and U[K,2] do not have any mentor freelancer. A freelancer may or may not need to have a mentor so as to join present self-organizing system. While U[K,1] does not have a mentor, he has recruited N members, U[K+1,1], U[K+1,2], . . . , U[K+1,N], in which U[K+1,1] has recruited one member, U[K+2,1], and U[K+1,2] has recruited 4 members, U[K+2,2], U[K+2,3], . . . , U[K+2,5].

### Group Evolution Module

In one embodiment of the invention, the Group Evolution Module 302 enables the change of group members in a group, and the change includes but is not limited to adding a new group member, removing an existing group member, transferring a group member from one group into the group, banning a group member so that the member cannot participate in group activities for a period of time or permanently or cannot receive any benefit from the group such as group bonus, and so on. For example, the Group Evolution Module 302 may enable a freelancer to change the mentor or join another group of the self-organizing freelance system.

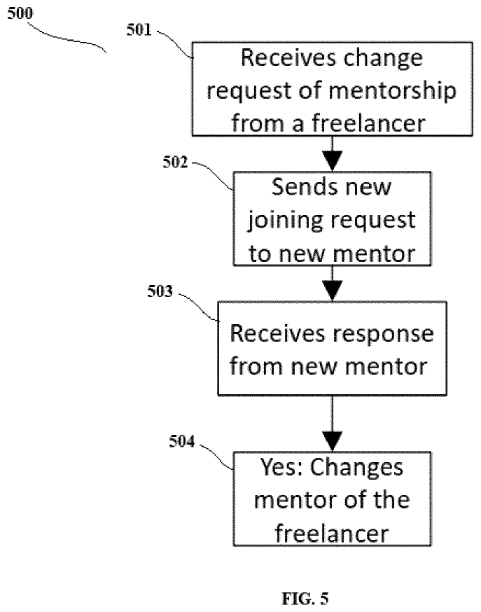

FIG. 5 is an exemplary flow diagram illustrating a method 500 for the Group Evolution Module 302 to make a response after receiving a change request of mentorship and/or group from a freelancer. The method begins when the Group Evolution Module 302 receives a request of changing mentorship from a freelancer 501. Said change request may include the identification, including but not limited to QR code, referral code, of the new mentor requested. Said change request may also include a note explaining why such a change is requested.

The Group Evolution Module 302 then sends the new joining request to the new mentor 502. After receiving such new joining request, the new mentor may evaluate the expertise, work history, client ratings and comments, and so on, that are provided by the freelance platform to the new mentor based on which the new mentor replies to the new joining request 503. After receiving the response from the new mentor, the group evolution module checks the response result and if the result is positive and the new mentor accepts the new group member, the group evolution module changes mentor of the freelancer 504 and updates database accordingly.

In one embodiment of the invention, the Group Evolution Module 302 may further facilitate a mentor freelancer aka group head to remove a particular freelancer from his group. The Group Evolution Module 302 provides an option for the mentor freelancer to submit a “Kick-Out Request” for a particular freelancer to the Group Evolution Module 302. Kick out of a freelancer means removing a freelancer from a group. After receiving the “Kick-Out Request”, the Group Evolution Module 302 may simply record this particular freelancer as having no mentor, thereby remove the particular freelancer from the group and update database accordingly.

In another embodiment of the invention, the Group Evolution Module 302 may provide an option for any group member to submit a “Kick-Out Request” for a particular freelancer in the group to the Group Evolution Module 302. In one embodiment of the invention, after receiving the “Kick-Out Request” from either the mentor freelancer or a group member, the Group Evolution Module 302 may send a poll request to all direct group members of this mentor freelancer so that each direct group member may vote on the kick-out request within a certain deadline, such as one week or one month. After receiving the voting result, the Group Evolution Module 302 checks if the voting result meets a certain performance criterion. If the voting result meets a certain performance criterion, the Group Evolution Module 302 will remove this particular freelancer from the group and may record this particular freelancer as having no mentor and update database accordingly. In one example of the embodiment, the performance criterion can be more than 50% of the voted members accepts the “Kick-Out Request”. In another example of the embodiment, the performance criterion may be more than a fixed number of members accepts the “Kick-Out Request”.

### Payment Calculation Module

The Payment Calculation Module 303 comprises a Freelance Earning Calculation Module 304 and a Multi-Tier Incentive Calculation Module 305, to calculate and disburse direct earning from work of a freelancer as well as indirect earning from working of the other freelancers, such as downline and/or group members. The Freelance Earnings Calculation module 304 in the Payment Calculation Module 303 of the Self-Organizing Freelance System 300 is configured to record part or all the transactions of online workers or freelancers, and calculate their earnings. It may also perform various other analytics pertaining to freelance transactions on the platform. Upon completion of a freelance job, the freelance earnings calculation module may also update the databases accordingly to insert new transactions data and earnings record.

The Multi-tier Incentive Calculation Module 305 is configured to calculate the indirect income, aka incentive payment, including but not limited to commissions and bonuses, for all users in the hierarchical freelance system based on data provided by the freelance earnings calculation module 304 and may update the databases accordingly to insert new transactions data and incentive earnings record. The Multi-tier Incentive Calculation Module 305 may receive a communication from the Freelance Earning Calculation Module 304 upon the completion of a freelance job or upon getting any earnings by a first freelancer. The Multi-Tier Incentive Calculation Module 305 may then use the earning of said first freelancer to determine the appropriate indirect earnings, e.g. incentives, commissions, or bonus to be paid to a second freelancer based on the freelancer hierarchy stored in the database.

Said determination of the indirect earnings, e.g. incentive or commission, which is denoted by y, may be an indirect earnings function of the direct earning of the first freelancer, which is denoted by x. One example of the indirect earnings function is a percentage, y=x*a %. Another example of the indirect earnings function is a mapping table, e.g. if x>10 and x<100, then y=5; if x>100 and x<1000, then y=20. Upon making this determination, the Multi-Tier Incentive Calculation Module 305 may automatically facilitate the appropriate payments to the online workers or freelancers associated with completion of online work, e.g. a freelance service, according to the self-organizing freelance platform 300.

Optionally, the Payment Calculation Module 303 may interface with, via input/output module, various payment entities that may be provided by third-party vendors to distribute payments to the freelance individuals. Said payments may be distributed upon the completion of the calculation of a payment. Said payments may be accumulated and paid to freelancers at particular time, such as once a week, once a month, every 25th of each month, and so on. Said payments may also be accumulated and paid to freelance individual upon withdrawal request submitted by said freelancer.

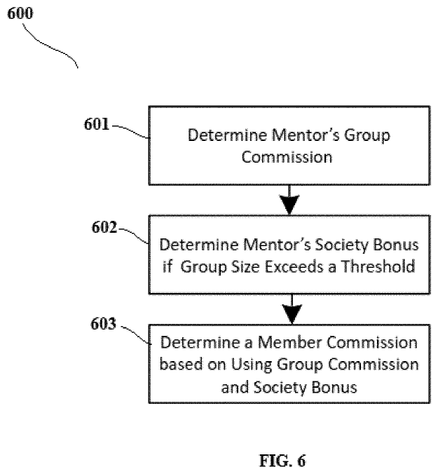

FIG. 6 shows a simplified flow diagram illustrating one method 600 used by the Multi-Tier Incentive Calculation Module 305 to determine the incentive payment to the freelancers. The Multi-Tier Incentive Calculation Module 305 first determines the group commission of a mentor, aka group head 601 using an indirect earnings function. For example, a freelancer may earn a group commission from the earnings of the members in his downline freelancers on his multi-tier organization or tree. In one example of the invention, said group commission can be a percentage of the freelance earnings of each downline freelance member. For example, group commission can be 10% of the freelance earnings of all directly hired freelance members, i.e. the freelancers on the first level of the recruiting tree of the mentor freelancer. In another example of the invention, the percentage of the freelance earnings of each downline freelance member used to determine the group commission may be a function of the level on the recruiting tree of this mentor freelancer. For example, group commission can be the total of 10% of the freelance earnings of all freelances on the first level, plus 5% of the freelance earnings of all freelancers on the second level, plus 2.5% of the freelance earnings of all freelancers on the third level.

In one embodiment of the invention, when the Multi-Tier Incentive Calculation Module 305 determines mentor's group commission, the Multi-Tier Incentive Calculation Module 305 may first examine if the mentor freelancer and his group meet certain performance criterion and pays the group commission to the mentor freelancer only if said performance criterion is met. In one example, said performance criterion can be a minimum number of new freelancers that needs to be recruited in a certain period of time. In another example, said performance criterion can be a minimum number of freelance jobs that needs to be completed in a certain period of time by either the mentor freelancer or his group. In one example, said performance criterion can be a minimum amount of total freelance earnings that needs to be achieved by the mentor freelancer or his group members in a certain period of time.

The Multi-Tier Incentive Calculation Module 305 may further determine the mentor's society bonus 602 using a second indirect earnings function only if the group of the mentor meets certain society criterion. Additional incentive payment can be paid to the mentor if his group becomes a society. In one example of the embodiment, the society criterion is that the total number of freelancers on the recruiting tree of the mentor freelancer needs to exceed a number, e.g. 100. In another example of the embodiment, the society criterion is that the total number of freelancers on the first level of the recruiting tree of the mentor freelancer needs to exceed a number, e.g. 50. In another example of the embodiment, a group is elevated to a society if the total number of freelancers on the first level of the recruiting tree of the mentor freelancer exceeds a number, e.g. 50 and the society is degraded to a group if the total number drops below another lower number, e.g. 40. In one example of the embodiment, the society criterion is the total amount of freelance earnings of all the freelancers on the recruiting tree of the mentor freelancer in a predetermined period should exceed a number, e.g. 1000 USD. In one more example of the embodiment, the society criterion is the total amount of freelance earnings of all the freelancers on the first level of the recruiting tree of the mentor freelancer in a predetermined period should exceed a number, e.g. 1000 USD.

To reward a mentor freelancer that has made the extraordinary contribution of building a society, the Multi-tier Incentive Calculation Module 305 determines that the mentor's society bonus may be paid to the mentor freelancer which is calculated using an indirect earnings function. For example, a freelancer may earn a society bonus calculated based on using the earnings of the members in his downline freelancers on his recruiting tree. In one example of the invention, said society bonus is a percentage of the freelance earnings of each downline freelance member. For example, the society bonus is 5% of the freelance earnings of all directly hired freelance members, i.e. the freelancers on the first level of his recruiting tree. In another example of the embodiment, the percentage of the freelance earnings of each downline freelance member used to determine the society bonus may be a function of the level on the recruiting tree. For example, society bonus is the total of 5% of the freelance earnings of all freelances on the first level, plus 4% of the freelance earnings of all freelancers on the second level, plus 3% of the freelance earnings of all freelancers on the third level. In another example of the embodiment, said society bonus is a percentage of the total of the group commissions plus society bonuses of all directly hired freelance members, i.e. the freelancers on the first level of the recruiting tree.

In one embodiment of the invention, when the Multi-tier Incentive Calculation Module 305 determines mentor's society bonus, the Multi-tier Incentive Calculation Module 305 may first examine if the mentor freelancer and his group meet certain society activity criterion and pays the society bonus to the mentor freelancer only if said society activity criterion is met. In one example, said society activity criterion may be a minimum number of new freelancers that needs to be recruited in a certain period of time. In another example, said society activity criterion can be a minimum number of freelance jobs that needs to be completed in a certain period of time by either the mentor freelancer or his group. In one example, said society activity criterion may be a minimum amount of total freelance earnings that needs to be achieved by the mentor freelancer or his group in a certain period of time.

According to one embodiment of the invention, the Multi-tier Incentive Calculation Module 305 also determines a Member Commission for members on the recruiting tree of the mentor freelancer based on using an indirect earnings function of earnings of other group members of the mentor freelancer. For example, the Member Commission can be a function of Group Commission and Society Bonus of the mentor freelancer. The idea being, that each freelancer will work to help other group members of his mentor to increase the freelance earnings of the whole group, thereby increasing the Member Commission of the freelancer himself. This motivates the creation of a self-organizing freelance groups where each freelancer helps each other. Freelancers will also tend to join groups where each freelancer performs well and mentors will be more willing to accept freelancers that can contribute to the freelance community.

In one example of the embodiment, the Member Commission of a freelancer can be a function of Group Commission and Society Bonus of the freelancer's mentor. For example, the Member Commission of a freelancer may be a percentage of Mentor's Group Commission plus Mentor's Society Bonus divided by number of direct group members of the mentor. In one embodiment of the invention, when the Multi-tier Incentive Calculation Module 305 determines freelancer's Member Commission, the Multi-tier Incentive Calculation Module 305 may first examine if the freelancer meets certain performance criterion and pays the Member Commission to the freelancer only if said performance criterion is met. In one example, said performance criterion may be a minimum number of new freelancers that needs to be recruited by said freelancer in a certain period of time. In another example, said performance criterion may be a minimum number of freelance jobs that needs to be completed by the freelancer in a certain period of time. In one example, said performance criterion may be a minimum amount of total freelance earnings that needs to be achieved by the freelancer in a certain period of time.

1. A self-organizing freelance system for a freelance platform, wherein the self-organizing system comprises:
a group formation module that is configured to arrange freelancers in multiple tiers and allow a second freelancer to join the group of a first freelancer and become downline freelancer of said first freelancer, wherein said first freelancer is arranged in one tier of the multiple tiers of freelancers on the freelance platform;
a group evolution module that is configured to receive a request of changing a group member of the group of said first freelancer and to perform the change, wherein said change comprises at least one selected from the group of joining of a new member, removing of an existing member, and banning of an existing member; and
a payment calculation module that comprises:
a freelance earning calculation module that is configured to calculate the direct earnings from freelance work for freelancers on the freelance platform;
and a multi-tier incentive calculation module that is configured to calculate the indirect earnings for a freelancer based on earnings of other freelancers.

2. The self-organizing freelance system of claim 1, wherein the group formation module is configured to provide said first freelancer a message in the form of direct link or code, which can be used by said second freelancer to join the group of said first freelancer and become a downline freelancer of said first freelancer.

3. The self-organizing freelance system of claim 1, wherein the group formation module is configured to allow one freelancer of the group of said first freelancer to create a team with said first freelancer or said second freelancer to provide freelance service together over the freelance platform.

4. The self-organizing freelance system of claim 1, wherein the group formation module is further configured to provide a communication tool to allow members of the group of said first freelancer to communicate with each other.

5. The self-organizing freelance system of claim 4, wherein the communication tool comprises at least one selected from the group of chat app, online messenger, email group, forum, audio and video conference, or calendar sharing.

6. The self-organizing freelance system of claim 1, wherein the group evolution module comprises a non-transitory computer-readable storage medium, having embodied thereon a program executable by a processor to cause a computer to carry out steps of:
receiving a request of changing group from said second freelancer;
sending a joining request to a third freelancer; and
receiving a response to said joining request from said third freelancer.

7. The self-organizing freelance system of claim 1, wherein the group evolution module is configured to provide an option to said first freelancer, allowing said first freelancer to submit a request to kick out said second freelancer.

8. The self-organizing freelance system of claim 7, wherein the group evolution module is further configured to remove said second freelancer from the group after having received the request to kick out said second freelancer.

9. The self-organizing freelance system of claim 1, wherein the group evolution module is configured to provide an option to a third freelancer in the group of said first freelancer, allowing said third freelancer to submit a request to kick out said second freelancer.

10. The self-organizing freelance system of claim 9, wherein the group evolution module is further configured to
provide a voting option to group members of the group of said first freelancer after having received the request to kick out said second freelancer, allowing the group members to vote to kick out said second freelancer in the group;
and if the voting result meets certain voting criterion, removes said second freelancer from the group of said first freelancer.

11. The self-organizing freelance system of claim 1, wherein the multi-tier incentive calculation module is configured to provide to a receiving freelancer an indirect payment that is determined by using a function of the earning of another freelancer in the multi-tier arrangement of the group formation module.

12. The self-organizing freelance system of claim 11, wherein said indirect payment is provided only if said receiving freelancer must meet a particular performance criterion.

13. The self-organizing freelance system of claim 12, wherein said performance criterion comprises at least one selected from the group of:
the group size of said receiving freelancer exceeds a threshold;
the freelance earning of said receiving freelancer exceeds a threshold;
the number of jobs completed by said receiving freelancer exceeds a threshold;
the freelance earning of the group of said receiving freelancer exceeds a threshold;
the number of new freelancers recruited by said receiving freelancer exceeds a threshold; and
the number of jobs completed by the group of said receiving freelancer exceeds a threshold.

14. The self-organizing freelance system of claim 1, wherein the multi-tier incentive calculation module comprises a non-transitory computer-readable storage medium, having embodied thereon a program executable by a processor to cause a computer to carry out steps of:
determining a group commission for said first freelancer based on using a first function of earnings of downline freelancers of said first freelancer; and
determining a society bonus for said first freelancer based on using a second function of earnings of downline freelancers of said first freelancer if said first freelancer meets a society criterion.

15. The self-organizing freelance system of claim 14, wherein the program further causes the computer to carry out steps of:
determine a member commission for said first freelancer based on using a third function of earnings of freelancers that have the same group head as said first freelancer.

16. The self-organizing freelance system of claim 14, wherein said society criterion comprises at least one selected from the group of:
the group size of said first freelancer exceeds a threshold;
the freelance earning of said first freelancer exceeds a threshold;
the number of jobs completed by said first freelancer exceeds a threshold;
the freelance earning of the group of said first freelancer exceeds a threshold;
the number of new freelancers recruited by said first freelancer exceeds a threshold; and
the number of jobs completed by the group of said first freelancer exceeds a threshold.
